(19) United States
(12) Patent Application Publication
(10) Pub. No.: US 2013/0026146 A1
(43) Pub. Date: Jan. 31, 2013

(54) PRODUCTIVITY AND EFFICIENCY IMPROVEMENTS FOR LASER REPETITIVE PULSE MELT DEEP CRYSTALLIZATION

(71) Applicant: Jacob Newman, Palo Alto, CA (US)

(72) Inventor: Jacob Newman, Palo Alto, CA (US)

(73) Assignee: Applied Materials, Inc., Santa Clara, CA (US)

(21) Appl. No.: 13/550,208

(22) Filed: Jul. 16, 2012

Related U.S. Application Data
(60) Provisional application No. 61/511,512, filed on Jul. 25, 2011.

(51) Int. Cl. B23K 26/02

(52) U.S. Cl. 219/121.78

(57) ABSTRACT

The present invention generally relates to methods and apparatus for thermally processing substrates. The apparatus include an energy source, a plurality of chambers, and one or more energy switches. The one or more optical switches are adapted to direct an amount of energy emitted from the energy source to one of the plurality of chambers, and then change switch positions to direct the energy to a second of the plurality of chambers at a preselected time. The plurality of chambers may each include a heated support and a plurality of lamps therein to heat a substrate. The methods generally include thermally processing a first substrate in a first chamber while preheating or aligning a second substrate in a second chamber. After the first substrate is thermally processed, the second substrate is processed in the second chamber using the same energy source as was used to process the first substrate.

### CROSS-REFERENCE TO RELATED APPLICATIONS

This application claims benefit of U.S. Provisional Patent Application Ser. No. 61/511,512, filed Jul. 25, 2011, which is herein incorporated by reference.

### BACKGROUND OF THE INVENTION

1. Field of the Invention

Embodiments of the invention generally relate to methods and apparatus for thermally processing substrates.

2. Description of the Related Art

Placement of dopant atoms in substrates, such as semiconductor substrates, is controlled by implanting dopants into the substrates and then thermally annealing the substrates. During annealing, a substrate is typically heated to high temperatures so that various chemical and physical reactions can take place within the substrate. For example, annealing may create a more crystalline structure in the substrate, or may activate dopants by incorporating the dopant atoms into the lattice structure of the substrate.

One way to thermally anneal a substrate is through the use of lasers. Thermal processing with lasers can be improved by properly aligning the substrate within a thermal processing chamber prior to the commencement of the annealing process. In some circumstances, preheating the substrate prior to annealing the substrate with the laser can also improve thermal processing. However, alignment and preheating of the substrate are time consuming and reduce substrate throughput.

Therefore, there is a need for methods and apparatus for increasing substrate throughput in thermal processing devices.

### SUMMARY OF THE INVENTION

The present invention generally relates to methods and apparatus for thermally processing substrates. The apparatus include an energy source, a plurality of chambers, and one or more energy switches, such as an optical switch. The one or more energy switches are adapted to direct an amount of energy emitted from the energy source to one of the plurality of chambers, and then change switch positions to direct the energy to a second of the plurality of chambers at a preselected time. The plurality of chambers may each include a heated support and a plurality of lamps therein to heat a substrate. The methods generally include thermally processing a first substrate in a first chamber while preheating or aligning a second substrate in a second chamber. After the first substrate is thermally processed, the second substrate is processed in the second chamber using the same energy source as was used to process the first substrate.

In one embodiment, an apparatus comprises a plurality of chambers and an energy switch adapted to direct electromagnetic radiation to each of the plurality of chambers. An energy source is adapted to generate electromagnetic radiation and to provide the electromagnetic radiation through the energy switch to each of the plurality of chambers.

In one embodiment, an apparatus comprises a plurality of chambers and an energy source positioned outside the plurality of chambers to generate electromagnetic radiation. An energy switch is adapted to direct electromagnetic radiation from the energy source to each of the plurality of chambers individually.

In another embodiment, a method for processing substrates comprises generating electromagnetic radiation, and directing the electromagnetic radiation through an energy switch to a surface of a first substrate located within a first chamber. The path of the electromagnetic radiation through the energy switch is then changed, and the electromagnetic radiation is directed through the energy switch to a surface of a second substrate located within a second chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1C are schematic plan views of processing systems according to embodiments of the invention.

FIG. 2 is a flow diagram of a method of thermally processing substrates in the processing system having two chambers.

FIG. 3 is a schematic illustration of a chamber according to one embodiment of the invention.

FIG. 4 is a flow diagram of a method of processing a substrate in a chamber.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present invention generally relates to methods and apparatus for thermally processing substrates. The apparatus include an energy source, a plurality of chambers, and one or more energy switches, such as an optical switch. The one or more energy switches are adapted to direct an amount of energy emitted from the energy source to one of the plurality of chambers, and then change switch positions to direct the energy to a second of the plurality of chambers at a preselected time. The plurality of chambers may each include a heated support and a plurality of lamps therein to heat a substrate. The methods generally include thermally processing a first substrate in a first chamber while preheating or aligning a second substrate in a second chamber. After the first substrate is thermally processed, the second substrate is processed in the second chamber using the same energy source as was used to process the first substrate.

Embodiments of the present invention utilize a single energy source shared among a plurality of chambers in order to reduce the down time of the energy source, which can represent at least 60 percent of the total cost of an entire processing system. Thus, while the energy source is performing a thermal process on a first substrate in a first process chamber, a second substrate in a second process chamber can be aligned and/or subjected to a preheat process. Once thermal processing of the first substrate is complete, the energy source can be directed to the second chamber to process the second substrate. Thus, energy source downtime is minimized and throughput is increased. While the second substrate is being thermally processed, a third substrate may be prepared for processing in the first chamber.

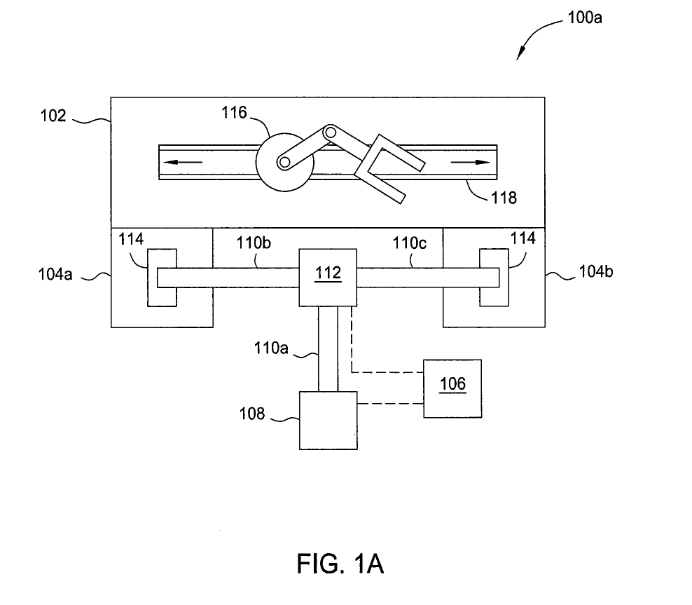

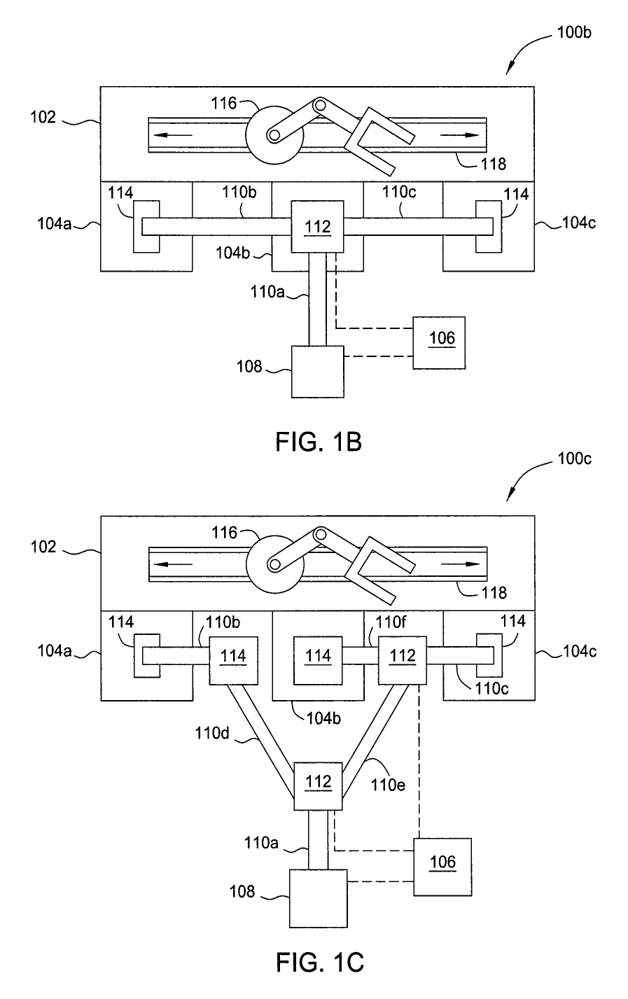

FIGS. 1A-1C are schematic plan views of processing systems according to embodiments of the invention. FIG. 1A illustrates a processing system 100a. The processing system 100a includes a front end 102, a first chamber 104a, a second chamber 104b, and an energy source 108. The front end 102 includes a robot 116 movably positioned on a track 118. The robot 116 is adapted to transfer one or more substrates from a substrate storage cassette (not shown) to the interior of the first chamber 104a and the second chamber 104b. The first chamber 104a and the second chamber 104b are thermal processing chambers, such as laser annealing chambers, which are adapted to thermally process one or more substrates therein. Generally, the first chamber 104a and the second chamber 104b are substantially identical; however, it is contemplated that the first chamber 104a and the second chamber 104b may be different.

The energy source 108 is adapted to deliver electromagnetic energy to the surfaces of substrates located within the first chamber 104a and the second chamber 104b, generally one chamber at a time. The electromagnetic radiation is delivered to the first chamber 104a and the second chamber 104b through guides 110a, 110b, and 110c which are positioned above the first chamber 104a and the second chamber 104b. The guides 110a-110c may be lenses, mirrors, and/or other optical components when the energy source 108 is a light source, or may be wave guides when the energy source 108 is an RF generator or microwave generator. Each of the guides 110b and 110c include optics 114, such as mirrors, positioned in the distal end thereof and adapted to direct the electromagnetic radiation toward substrates located within the first chamber 104a and the second chamber 104b. The lengths of guides 110b and 110c are generally equal in order to maintain a consistent optical path length (i.e., the distance the electromagnetic radiation travels) to each of the first chamber 104a and the second chamber 104b in order to maintain process consistency between substrates processed in each of the first chamber 104a and the second chamber 104b.

An energy switch 112, such as an optical switch, is positioned at the intersection of guides 110a, 110b, and 110c, and is adapted to divert the electromagnetic radiation traveling through guide 110a to one of the guides 110b or 110c in order to provide electromagnetic radiation to one of the chambers 104a or 104b. The energy switch 112 includes one or more internal mirrors which can be positioned to direct electromagnetic radiation to the first chamber 104a, and then repositioned to direct electromagnetic radiation to the second chamber 104b. Thus, the energy source 108 provides electromagnetic radiation to both the first chamber 104a and the second chamber 104b, generally a single chamber at a time. A controller 106 is coupled to the energy source 108 and the energy switch 112, and is adapted to control the energy source output and the position of the energy switch.

The energy source 108 includes an optical assembly as well as an energy generator such as an optical radiation source (e.g., lasers, flash lamps, etc.), an electron beam source, an ion beam source, or a microwave energy source. The energy generator is adapted to produce energy which is directed into the optical assembly. The optical assembly shapes the energy as desired for delivery through the guides 110a-110c to a substrate located within the first chamber 104a or the second chamber 104b. The optical assembly generally includes lenses, filters, mirrors, and the like configured to focus, polarize, de-polarize, filter or adjust coherency of the energy produced by the energy generator located within the energy source 108. The energy source 108 may also be adapted to provide pulses of energy, in which case, the energy source 108 may further include a fast shutter that can be opened and closed to allow pulses of electromagnetic radiation to pass therethrough.

FIG. 1B is schematic plan view of a processing system 100b having three chambers 104a-104c. Thus, in contrast to the processing system 100a shown in FIG. 1A, the energy switch 112 illustrated in FIG. 1B is adapted to direct electromagnetic radiation from the energy source 108 to at least three different chambers. However, as is apparent in FIG. 1B, the optical path length from the energy source 108 to the second chamber 104b is less than the optical path length from the energy source 108 to the first chamber 104a or the third chamber 104c. Thus, it may be desirable to compensate for the difference in optical patch length between the chambers so that substrates in each of the chambers are processed consistently. The optical path length may be compensated for by increasing the distance the light travels (for example, by inclusion of extra mirrors within the energy switch 112) when electromagnetic radiation is being directed into the second chamber 104b. Additionally or alternatively, the controller 106 can vary the output of the energy source 108, for example, by reducing the output power, to compensate for the difference in path length.

FIG. 1C is a schematic illustration of a processing system 100c having three chambers 104a-104c. In contrast to processing system 100b, the processing system 100c utilizes extra guides 110d-110f and a second energy switch 112 to equalize the optical path between the energy source 108 and each of the chambers 104a-104c. To deliver electromagnetic energy to the first chamber 104a, the electromagnetic energy travels through guide 110a to the first energy switch 112, which directs the electromagnetic energy to the guide 110d. The optics 114 (such as a prism, lens, or mirror) direct the electromagnetic radiation through the guide 110b to another set of optics 114, which direct the electromagnetic radiation into the first chamber 104a. To deliver electromagnetic radiation to the second chamber 104b, the controller 106 repositions the optics within the first energy switch 112 such that electromagnetic energy from the energy source 108 is directed down the guide 110e. A second energy switch coupled to the guide 110e directs the electromagnetic radiation through a guide 110f to the optics 114 positioned above the second chamber 104b. The optics 114 then direct the electromagnetic radiation into the chamber 104b.

To deliver electromagnetic radiation to the third chamber 104c, the controller 106 repositions the optics within the second energy switch 112 such that light traveling through guide 110e is directed into guide 110c. The light traveling through guide 110c is then directed into the chamber 104c by optics 114 positioned above chamber 104c. Preferably, the length of guides 110d and 110e are equal, as is the length of guides 110b, 110f, and 110c. Thus, the optical path length from the energy source 108 to each of the chambers 104a, 104b, and 104c is equal, resulting in consistent thermal processing of substrates in each of the chambers 104a, 104b, and 104c.

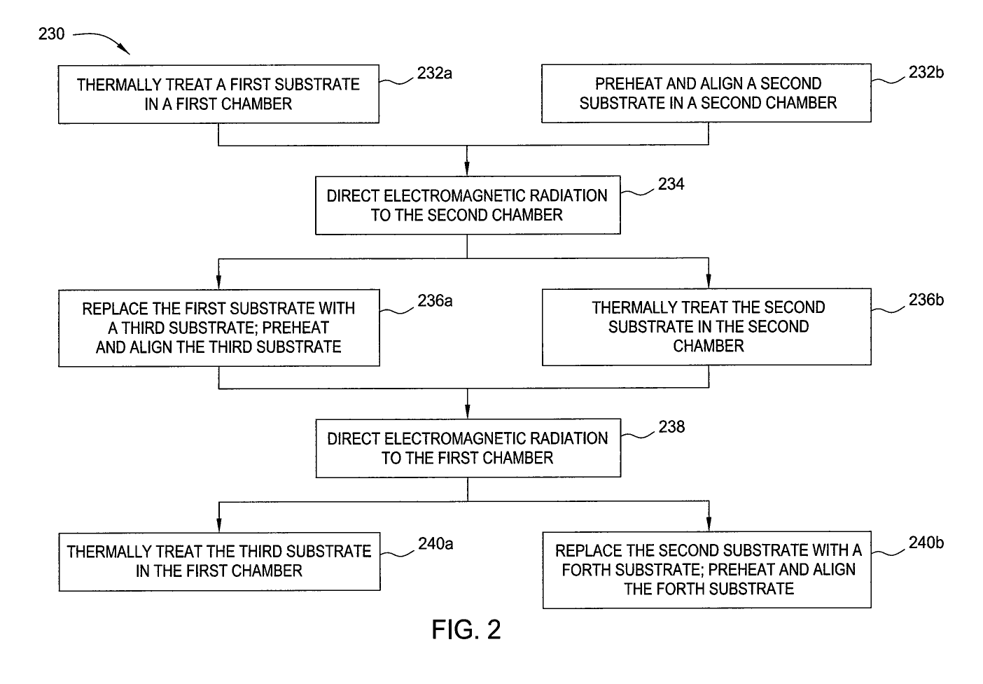

FIG. 2 is a flow diagram 230 of a method of thermally processing substrates in the processing system having two chambers, such as the processing system 100a shown in FIG. 1A. It is to be understood, however, that flow diagram 230 is applicable to other processing systems. The flow diagram begins at operation 232a in which a first substrate which has previously been aligned and preheated is thermally processed in a first chamber using an energy source. Thermal processing of the substrate generally includes annealing the substrate through the application of electromagnetic radiation to the substrate surface. Simultaneously with operation 232a, operation 232b occurs. In operation 232b, a second substrate located in a second chamber is subjected to a preheat process and is aligned on a support present within the second chamber. During the preheat process, the substrate is heated by one or more of a heated substrate support and a plurality of lamps to a temperature within a range of about 300 degrees Celsius to about 400 degrees Celsius. Thus, as a first substrate is being thermally processed, a second substrate is being prepared for thermal processing.

In operation 234, after the completion of the thermal processing of the first substrate, and after completion of the preheating and alignment of the second substrate, the energy switch is repositioned to direct electromagnetic energy to the second processing chamber. In operation 236a, the first substrate in the first chamber is removed and is replaced with a third substrate. The third substrate is then subjected to a preheat process and is aligned. Simultaneously, in operation 236b, the second substrate located in the second chamber is thermally processed using the same energy source used for thermal processing in the first chamber. Thus, the second substrate in the second chamber can be processed immediately after completion of thermal processing of the first substrate and alignment/preheating of the second substrate. Since preheating and alignment of the second substrate can occur during thermal processing of the first substrate, the downtime of the energy source is minimized, thus increasing substrate throughput of the system.

After the completion of operations 236a and 236b, the energy switch is repositioned in operation 238 and the electromagnetic energy emitted from the energy source is directed back to the first chamber. After operation 238, a third substrate is thermally processed in the first chamber during operation 240a. Simultaneously with operation 240a, operation 240b occurs. In operation 240b, the second substrate is removed from the second chamber and is replaced by a fourth substrate. The fourth substrate is then preheated and aligned. Flow diagram 230 may then continue is similar manner in order to process a predetermined number of substrates.

Although flow diagram 230 is described with reference to FIG. 1A, it is contemplated that a similar method may be performed in the processing systems illustrated in FIGS. 1B and 1C (e.g., systems having three chambers). In such an embodiment, two substrates can be preheated and/or aligned during thermal processing of a substrate in a third chamber. The utilization of a system having three (or more) chambers may be beneficial depending on the time require to thermally process, align, or preheat the substrates.

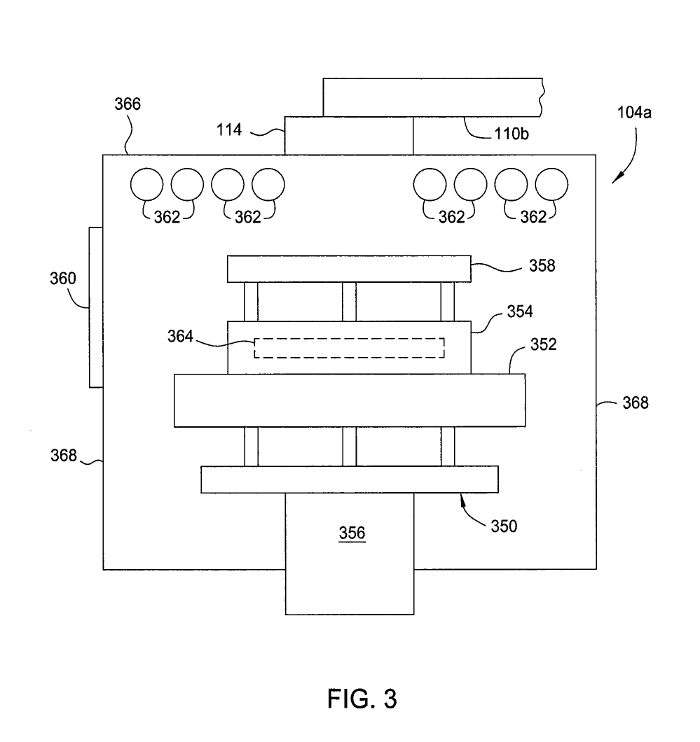

FIG. 3 is a schematic illustration of a chamber 104a according to one embodiment of the invention. The chamber 104a includes a lift pin assembly 350, a stage 352, and a support 354, such as a chuck, disposed within the chamber 104a. An opening 360, such as a slit valve, is formed within the body of the chamber 104a to allow for ingress and egress of a substrate 358. The substrate 358 may be positioned on the lift pin assembly 350 via a robot 116 (shown in FIG. 1A) which can enter the chamber 104a through the opening 360. The lift pin assembly 350 is coupled to and disposed on a lifting assembly 356 which is adapted to actuate the lift pin assembly 350 to position the substrate 358 on the support 354. The support 354 may contain one or more heating elements 364, such as a resistive heating element, to apply heat to the substrate 358 prior to or during processing. The support 354 is movable in the X-Y direction relative to the stage 352 to position the substrate 358 beneath the optics 114 to accept electromagnetic radiation traveling through the guide 110b.

A plurality of lamps 362 are disposed above the support 354 and the substrate 358. The lamps 362 are coupled to the underside of the chamber lid 366, however, it is contemplated that the lamps 362 may be located in other positions, such as on the walls 368 of the chamber 104a. The lamps 362 may be xenon excimer, quartz infrared, infrared, or halogen lamps adapted to heat the substrate 358 in combination with or as an alternative to the heating element 364 in the support 354. It is contemplated that when the lamps 362 are utilized as the sole heating source for the substrate 358, the support 354 may not include a heating element 364. Additionally, it is to be understood that while the description of FIG. 3 is made in reference to chamber 104a, the above description would likewise be applicable to chambers 104b and 104c.

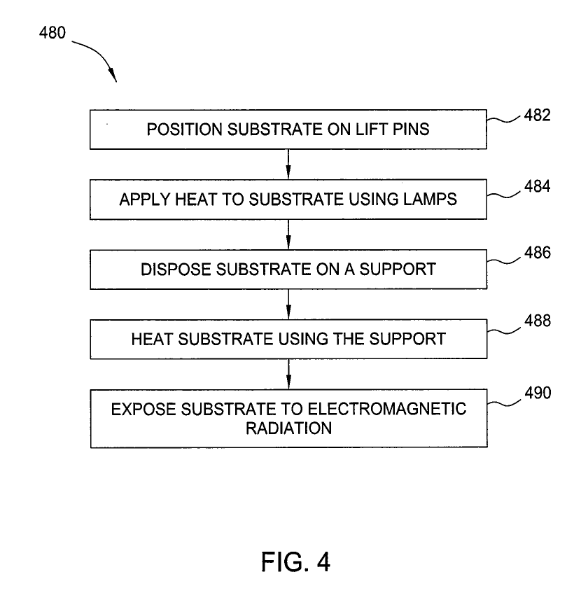

FIG. 4 is a flow diagram 480 of a method of processing a substrate in chamber, such as chamber 104a shown in FIG. 3. It is to be understood, however, that flow diagram 480 is applicable to other chambers. Flow diagram 480 begins at operation 482 in which a substrate is positioned on the lift pins located in an elevated position above a support. In operation 484, heat is applied to the substrate via a plurality of lamps to increase the temperature of the substrate. The application of heat to the substrate by the lamps has several benefits. First, accuracy of the thermal processing (i.e., exposure of the substrate to the electromagnetic radiation) is increased. This is due to increased accuracy of alignment between the support and the stage. When heating the substrate using only a resistive heater within the support, the support must exceed the desired process temperature by several hundred degrees Celsius to quickly heat the substrate to processing temperatures. This often results in undesired heating of other chamber components, for the example the stage, especially when insulation between the stage and the support is insufficient. Due to the differences in thermal expansion of different materials within the chamber, alignment of the support relative to the stage (which is often within several microns or less) can be compromised. However, since the lamps provide some heat to the substrate, it is not necessary for the support to be heated to such a high temperature. Therefore, other components within the chamber, such as the stage, are not heated to as high of a temperature, and the differences in thermal expansion do not effect accuracy as much as they otherwise would.

Secondly, processing time within the chamber is reduced by heating the substrate using two heating sources (a heated support and lamps) rather than one. Thus, the substrate can be elevated to the desired processing temperature more quickly, and more substrates can be processed per unit time. Third, the likelihood of thermal shock to incoming substrates is reduced. Substrates positioned on the lift pins are generally at room temperature (for example, about 25 degrees Celsius), while internal chamber components such as the support, may be at several hundred degrees Celsius due to previous thermal processing of other substrates within the chamber. Thus, placement of the substrate directly on the support may damage the substrate. However, heating the substrate with the lamps prior to placement of the substrate on the support reduces the difference in temperature between the substrate and the support, and thus, also reduces the likelihood of thermal shock to the substrate.

In operation 486, the substrate is disposed on the support and aligned relative to the stage via vertical actuation of the lift pins. In operation 488, the substrate may continue to be heated by the heating element within the support until the substrate reaches a predetermined process temperature. It is contemplated that the lamps may continue to heat the substrate during operation 488, or that heating with the lamps may be halted for operation 488. In operation 490, after the substrate has reached the predetermined processing temperature, the substrate is exposed to electromagnetic radiation to thermal process the substrate.

Flow diagram 480 describes one embodiment for processing a substrate; however, other embodiments are also contemplated. In another embodiment, it is contemplated that operation 484 may begin simultaneously with, rather than prior to, operation 488. In yet another embodiment, it is contemplated that operation 488 may be excluded. In yet another embodiment, it is contemplated that one or more process gases may be present in the chamber during exposure to electromagnetic radiation.

Benefits of the present invention include methods and apparatus for increasing substrate throughput. Embodiments of the present invention may utilize a single energy source to process substrates in a plurality of chambers, thus reducing the downtime of the energy source. Additionally, performing alignment and preheating processes on a first substrate in a first chamber while thermally processing a second substrate in a second chamber allows for more efficient processing of substrates within a processing system. Furthermore, the use of an energy switch to divert electromagnetic radiation to a plurality of chambers results in a lower cost of production per finished device, since only a single energy source is required, which is often the most expensive component of the system. Additional benefits include a reduction in processing time, increased accuracy of alignment, and a reduction in thermal shock due at least in part to the use of multiple heating sources (e.g., lamps and a heated support).

While the foregoing is directed to embodiments of the present invention, other and further embodiments of the invention may be devised without departing from the basic scope thereof, and the scope thereof is determined by the claims that follow.

We claim:

1. An apparatus, comprising:
a plurality of chambers;
an energy source to generate electromagnetic radiation; and
an energy switch to direct electromagnetic radiation to the plurality of chambers.

2. The apparatus of claim 1, wherein the apparatus has only a single energy source to generate electromagnetic radiation for annealing of substrates within the plurality of chambers.

3. The apparatus of claim 1, wherein the plurality of chambers includes two chambers.

4. The apparatus of claim 1, wherein the plurality of chambers includes three chambers.

5. The apparatus of claim 1, further comprising a plurality of guides, wherein a first guide couples the energy source to the energy switch, a second guide couples the energy switch to a first chamber, and a third guide couples the energy switch to a second chamber.

6. The apparatus of claim 1, wherein the optical path between the energy switch and each of the plurality of chambers is substantially equal.

7. The apparatus of claim 1, wherein the energy switch directs the electromagnetic energy to each of the chambers individually.

8. An apparatus, comprising:
a plurality of chambers;
an energy source to generate electromagnetic radiation positioned outside the plurality of chambers; and
an energy switch to direct electromagnetic radiation from the energy source to each of the plurality of chambers individually.

9. The apparatus of claim 8, wherein the plurality of chambers includes two chambers.

10. The apparatus of claim 8, wherein the plurality of chambers includes three chambers.

11. The apparatus of claim 8, further comprising a plurality of guides coupling the energy source to the plurality of chambers.

12. The apparatus of claim 8, wherein an optical path between the energy source and each of the plurality of chambers is substantially equal.

13. A method for processing substrates, comprising:
generating electromagnetic radiation;
directing the electromagnetic radiation through an energy switch to a surface of a first substrate located within a first chamber;
changing the path of the electromagnetic radiation using the energy switch; and
directing the electromagnetic radiation through the energy switch to a surface of a second substrate located within a second chamber.

14. The method of claim 13, further comprising at least one of heating or aligning the second substrate within the second chamber at the same time as directing the electromagnetic radiation to the surface of the first substrate.

15. The method of claim 13, further comprising:
switching the direction of the electromagnetic radiation through the energy switch after directing the electromagnetic radiation to the second substrate located within the second chamber; and
directing the electromagnetic radiation through the energy switch to a surface of a third substrate located within a third chamber.

16. The method of claim 13, wherein the electromagnetic radiation is generated by a laser.

17. The method of claim 13, further comprising:
positioning the substrate on a plurality of lift pins prior to changing the path of the electromagnetic radiation;
applying heat to the second substrate from a plurality of lamps;
disposing the second substrate on a support; and
heating the support to apply heat to the second substrate.

18. The method of claim 17, wherein applying heat to the second substrate from the plurality of lamps occurs prior to disposing the second substrate on the support.

19. The method of claim 17, wherein applying heat to the second substrate from the plurality of lamps occurs after disposing the second substrate on the support.

20. The method of claim 17, wherein the electromagnetic radiation is generated by a laser.
